(19) United States
(12) Patent Application Publication
(10) Pub. No.: US 2025/0368011 A1
(43) Pub. Date: Dec. 4, 2025

(54) MACHINED GLASS SHEET AND ASSOCIATED MACHINING METHOD

(71) Applicant: SAINT-GOBAIN SEKURIT FRANCE, Thourotte (FR)

(72) Inventors: Laurent SILVESTRINI, COURBEVOIE (FR); Thierry DUMENIL, COURBEVOIE (FR)

(21) Appl. No.: 19/107,352

(22) PCT Filed: Aug. 31, 2023
(86) PCT No.: PCT/EP2023/073876

§ 371 Date: Feb. 27, 2025

(30) Foreign Application Priority Data
Aug. 31, 2022 (FR) FR2208719

(51) Int. Cl. B60J 1/00; B24B 9/10

(52) U.S. Cl. CPC B60J 1/006; B24B 9/10; B60J 1/008

(57) ABSTRACT

A glazed assembly includes a monolithic or laminated glazing and a finishing joint and/or seal, the glass sheet of the monolithic glazing, or, respectively, an outer sheet of the laminated glazing, these being referred to as “considered glass sheet”, including an outer first face and a second face separated by an edge face including a first curved part connected to the first face, a second curved part connected to the second face, and a flat part connecting the first and second curved parts together, the intersection between the flat part and a curved part being made up, in a cross-section, of a single point, the seal or joint including a contact part opposite the edge face and including a flat face in contact with the flat part, and a first protuberance in the continuation of the flat face and covering the entire curved part connected to the outer face.

### PRIOR ART

The present invention belongs to the general field of manufacturing glazing units. More particularly, it relates to a glass sheet machined at its edge face and a machining method for obtaining such a glass sheet. It also relates to a monolithic or laminated glazing comprising such a glass sheet, as well as a glazed assembly comprising a laminated glazing produced in this way and cooperating with a finishing joint and/or seal. The invention finds a particularly advantageous, though by no means limiting, application in the automotive field, in particular for the manufacture of windshields.

Conventionally, glass sheets used to make glazings, for example in the automotive sector as windshields, rear windows, side windows or glass roofs, are machined (or “shaped”) at their edge faces.

Such machining is carried out so that the edge face has a rounded profile, thus avoiding the presence of sharp edges between the main faces of the glass sheet and the edge face. This not only makes handling the glass sheet easier, but also makes it easier to glue a finishing joint and/or seal thereto, while preventing it from tearing.

It should be noted that the term “main faces” is conventionally used in the present disclosure to refer to the faces of the glass sheet with the largest surface areas.

The machining operation in question is carried out, as is well known, using a grinding wheel. This grinding wheel is typically made of steel and takes the form of a cylinder with an abrasive groove on its edge face (that is, on the surface parallel to the cylinder's axis of rotation). The abrasive nature of the groove surface is achieved by diamond particles bonded to said surface.

In practice, a glass sheet is machined by inserting it by the edge face into the groove while the grinding wheel is rotating. This insertion is carried out until the bottom of the abrasive surface is reached (that is, until the abrasive surface abuts), the latter being shaped so that, once the bottom is reached, the edge face of the glass sheet actually has the expected rounded shape.

It is therefore easy to understand that the expected shape of the edge face results from the fact that it is abraded by being inserted into the surface of the groove. Put another way, it is the geometry of the groove surface that determines the final shape of the edge face of the glass sheet.

FIG. 1 schematically shows an example of a grinding wheel 20 for machining the edge face 13 of a glass sheet 10, as is known from the state of the art. More particularly, FIG. 1 is a close-up partial view of a cross-section of the glass sheet 10 before it is machined.

The glass sheet 10 comprises two main faces, a first main face 11 (e.g. intended to face an external environment) and a second main face 12 (e.g. intended to face an internal environment). The two main faces 11, 12 are opposite one another and separated by the edge face 13. It should be noted that before machining, the edge face 13 is flat and orthogonal to the main faces 11, 12 (the glass sheet 10 resulting, for example, from a cutting operation in a larger glass plate).

In this example, the glass sheet 10 has a thickness equal to 2.1 mm and is shown at the start of its insertion, by the edge face 13, into a groove 21 of a grinding wheel 20 (only part of the grinding wheel 20 is shown here due to the partial close-up view). This configuration at the start of insertion into the groove 21 is more particularly referred to as the “initial machining configuration” in the remainder of the disclosure, and is characterized in this example by the junction edges between the edge face 13 and the two main faces 11, 12 coming into contact with the surface of the groove 21, it being understood that the glass sheet 10 extends perpendicularly to the edge face of the grinding wheel 20.

The groove 21 has a concave rounded shape (that is, the rounded shape is oriented toward the inside of the grinding wheel 20), and its surface is provided with diamond particles (not shown in FIG. 1) suitable for machining the glass sheet 10. More specifically, in the example shown in FIG. 1, the geometric shape of the surface of the groove 21 corresponds to an arc of a circle whose center is indicated by reference C_21 and whose radius is 1 mm.

The distance H_21 between the edge face 13 and the apex of the circular arc is referred to as the “machining height” in the remainder of the disclosure, and is 1.1 mm in this example. Note that the groove 21 is connected to edges 22, 23 of the grinding wheel (these edges 22, 23 forming part of the periphery of the grinding wheel 20) by rounded surfaces 24, 25 also corresponding to arcs of a circle whose respective centers are indicated by reference C_24, C_25 and whose respective radii are 2.1 mm.

FIG. 2 schematically shows a glazed assembly 30 according to the state of the art, comprising a laminated glazing 40, and used as a windshield for a motor vehicle, the glass sheets of said glazing being machined in accordance with the arrangements disclosed with reference to FIG. 1.

The glazing 40 comprises two glass sheets, an inner glass sheet 41 (that is, a glass sheet oriented so as to face the interior of the vehicle) and an outer glass sheet 42 (that is, a glass sheet oriented so as to face the external environment of the vehicle). The inner sheet 41 (respectively the outer sheet 42) has an inner main face 41_I interfacing with the vehicle interior, also known as face F4 (respectively an outer main face 42_E interfacing with the vehicle's external environment, also known as face F1). Additionally, each sheet 41, 42 comprises an edge face 41_T, 42_T.

The glazed assembly 30 also comprises a joint or seal 50, for example a finishing joint 50, comprising:
an “attachment” part 51 held in contact with the inner main face 41_I by adhesive means 60 of a type known per se,
a “contact” part 52 facing the edge face of the glazing 40 (that is, facing the edge faces 41_T, 42_T of the inner sheets 41, outer sheets 42) and having a flat face 53 in contact with the edge face 42_T of the outer glass sheet 42,
a protuberance 54 arranged in the continuation of the flat face 53 of the contact part 52. In this example, said protuberance 54 is designed to be flush with the outer main face 42_E of the outer glass sheet 42.

As shown in FIG. 2, the joint or seal 50, and more specifically the protuberance 52, does not completely cover the rounded part of the edge face 42_T connected to the outer main face 42_E. In fact, despite the fact that it may have a certain elasticity, the contact part 52, via its flat face 53, cannot fully hug the edge face 42_T, given the latter's rounded shape. The result (as shown in bold in FIG. 2) is that part 42_T_N of edge face 42_T is left exposed.

The presence of this exposed part 42_T_N is problematic. In fact, and according to a first aspect, it causes a visual defect in the glazing when viewed from the outside.

However, this exposed part 42_T_N also creates, at the junction with the protuberance 54, an area capable of receiving foreign bodies (e.g. dust, gravel, etc.) likely to damage the glazing.

Finally, yet another problematic aspect of this exposed part 42_T_N is the fact that the joint or seal 50 is unable to hold the outer sheet 42 in place over its entire edge face 42_T. This affects the impact resistance of the glazing at the junction with the protuberance 54.

It is worth noting that, although these issues have so far only been discussed in relation to the automotive sector, they also apply to other fields, such as construction.

### Overview of the Invention

The aim of the present invention is to remedy some or all of the drawbacks of the prior art, in particular those set out above, by proposing a solution which makes it possible to obtain a glass sheet machined in such a way that the edge has no exposed part when it engages with an already existing finishing joint and/or seal (that is, a prefabricated finishing joint and/or seal identical to those used in the prior art).

This solution therefore makes it possible to produce a glazed assembly (glazing fitted with a joint or seal) that has no visual defects when viewed from the outside, and is also very robust (no damage due to the presence of foreign bodies, good impact resistance) compared with solutions in the state of the art.

To this end, and according to a first aspect, the invention relates to a glass sheet comprising two main faces, a first main face and a second main face, opposite one another and separated by an edge face. Additionally, the edge face comprises, on at least part of the perimeter of the glass sheet:
a first convex curved part connected to the first main face,
a second convex curved part connected to the second main face,
a flat part interconnecting said first and second curved parts, the intersection between the flat part and a curved part being constituted, in a cross-section of the glass sheet, by a single point.

Thus, the glass sheet according to the invention has an edge face whose profile allows the protuberance of a prefabricated joint or seal to completely cover the curved part of the edge face connected to the outer face of the glass sheet. As a result, no part of the edge face is left exposed when engaging with a finishing joint and/or seal.

This particularly advantageous result is due to the presence of the flat part of the edge face of the glass sheet. In contrast to the state of the art, as shown in FIG. 2, a joint or seal engaging with the edge face of the glass sheet according to the invention is not constrained here to hug a fully rounded edge face, but can instead be pressed against the flat part of the edge face.

Put another way, the fact of having a flat part on the edge face, between two convex curved parts, makes it possible to reduce the machining height in comparison with embodiments of the state of the art, and therefore to have an edge face extending (in a cross-section to the glass sheet) over a shorter distance than that resulting from a fully curved edge face profile. This gain in distance is beneficial for the application of the joint or seal, whose protuberance can then completely cover the curved part of the edge face connected to the outer face of the glass sheet.

In particular embodiments, the glass sheet may further comprise one or more of the following features, taken alone or in any technically feasible combinations.

In particular embodiments, the first and second curved parts are circular arcs, for example circular arcs of identical respective radii and identical respective lengths.

In particular embodiments, the first and second curved parts are circular arcs of identical respective radii and identical respective lengths, the flat part being orthogonal to the main faces.

In particular embodiments, the angle, referred to as the “machining opening”, defining the gap between:
a first straight line tangential to the first curved part at the point of connection between said first curved part and the first main face,
a second straight line tangential to the second curved part at the point of connection between said second curved part and the second main face, is between 20° and 120°, more particularly between 20° and 80°, preferentially between 20° and 50°, for example 36°.

In particular embodiments, the first and second curved parts, as well as the flat part, are formed around the entire circumference of the glass sheet.

According to a second aspect, the invention relates to a method for machining at least one glass sheet, said method comprising steps of:
obtaining a glass sheet with a flat edge face,
inserting the glass sheet, by the edge face, into a groove of a rotating grinding wheel, said groove being provided with an abrasive surface, said insertion being carried out until the bottom of the groove is reached, which is shaped so that once the bottom is reached, the glass sheet conforms to the invention,
removing the glass sheet from the groove.

According to a third aspect, the invention relates to a monolithic glazing comprising a glass sheet according to the invention.

According to a fourth aspect, the invention relates to a laminated glazing comprising two sheets of glass, an inner sheet and an outer sheet, separated by an interlayer film, at least said outer sheet conforming to the invention.

In particular embodiments, the laminated glazing may further comprise several of the following features, taken alone or in any technically feasible combinations.

In particular embodiments, the inner sheet also conforms to the invention.

In particular embodiments, the inner and outer sheets are arranged so that, in a cross-section of the glazing, the respective flat parts of said inner and outer sheets are aligned with the edge face of the interlayer film.

According to a fifth aspect, the invention relates to a glazed assembly comprising a glazing according to the invention as well as a finishing joint and/or seal comprising:
a “contact” part arranged opposite the edge face of the glazing and having a flat face in contact with the flat part of the edge face belonging to the glass sheet, a main “outer” face of which is designed to interface with an external environment,
a protuberance arranged in the continuation of the flat face of the contact part, said protuberance being configured to cover the entire curved part connected to said outer main face.

According to a sixth aspect, the invention relates to a glazed assembly comprising a first glazing and a finishing joint and/or seal, the first glazing being a monolithic glazing comprising a glass sheet or the first glazing being a laminated glazing comprising two glass sheets, an inner sheet and an outer sheet, separated by an interlayer film,
the glass sheet of the monolithic glazing, respectively at least the outer sheet of the laminated glazing, each called “considered glass sheet” of the first glazing, comprising a first main face, called “outer main face”, intended designed to interface with an external environment and a second main face, opposed and separated by an edge face, called “first edge face”, the first edge face of the considered glass sheet of the first glazing comprising, over at least part of the perimeter of said considered glass sheet:
   a first convex curved part connected to the first main face of the considered glass sheet of the first glazing,
   a second convex curved part connected to the second main face of the considered glass sheet of the first glazing,
   a flat part interconnecting said first and second curved parts, the intersection between the flat part and a curved part being constituted, in a cross-section of the considered glass sheet of the first glazing, by a single point,
the finishing joint and/or seal comprising:
   a contact part facing the first edge face of the considered glass sheet of the first glazing and comprising a flat face in contact with the flat part of the first edge face of the considered glass sheet of the first glazing,
   a first protuberance arranged in the continuation of the flat face of the contact part, said first protuberance covering at least a portion of the curved part of the first edge face connected to said outer main face of the considered glass sheet of the first glazing.

Thus, the profile of the first edge face of the considered glass sheetquestion of the first glazing of the glazed assembly according to the invention makes it possible to reduce the curved exposed part of the considered glass sheet of the first glazing at the junction between the outer face of the considered glass sheet of the first glazing and the first protuberance compared with the state of the art.

This particularly advantageous result is due to the presence of the flat part of the edge face of the glass sheet. In contrast to the state of the art, as shown in FIG. 2, a joint or seal engaging with the edge face of the glass sheet according to the invention is not constrained here to hug a fully rounded edge face, but can instead be pressed against the flat part of the edge face.

Put another way, the fact of having a flat part on the edge face, between two convex curved parts, makes it possible to reduce the machining height in comparison with embodiments of the state of the art, and therefore to have an edge face extending (in a cross-section to the glass sheet) over a shorter distance than that resulting from a fully curved edge face profile. This gain in distance is beneficial for the application of the joint or seal, whose protuberance can then overlap at least a portion of the curved part of the edge face connected to the outer face of the glass sheet, so that a curved exposed portion of the first edge face at the junction between the outer face and the first protuberance is smaller than in the prior art.

Owing to these features, the glazed assembly according to the invention presents a better visual appearance when the glazed assembly is viewed with the naked eye, in particular from outside the vehicle, compared with the glazed assembly of the state of the art.

Additionally, the glazed assembly according to the invention features improved impact resistance.

The glazed assembly according to the sixth aspect of the invention may comprise one or more of the following features in any technically possible combination:
said first protuberance covers the entire curved part of the first edge face connected to said outer main face of the considered glass sheet of the first glazing.
the first and second curved parts of said first edge face are arcs of circle, for example arcs of circle of identical respective radii and identical respective lengths.
the first and second curved parts of the first edge face are arcs of circle of identical respective radii and identical respective lengths, the flat part being orthogonal to the main faces.
the angle, referred to as the “machining opening” of the considered glass sheet of the first glazing, defining the gap between a first straight line tangential to the first curved part of the first edge face at the point of connection between said first curved part and the first main face, and a second straight line tangential to the second curved part at the point of connection between said second curved part and the second main face, is between 20° and 120°, more particularly between 20° and 80°, preferentially between 20° and 50°, for example equal to 36°.
the first and second curved parts and the flat part of the first edge face are formed around the entire perimeter of the considered glass sheet of the first glazing.
the first glazing is a laminated glazing, the inner sheet of the first glazing conforming to the considered glass sheet of the first glazing as defined above.
the inner and outer sheets of the first glazing are arranged so that, in a cross-section of the first glazing, the respective flat parts of said inner and outer sheets are aligned with the edge face of the interlayer film.
said glazed assembly further comprises a second glazing, the second glazing being chosen from a monolithic glazing comprising a glass sheet or a laminated glazing comprising two glass sheets, an inner sheet and an outer sheet, separated by an interlayer film, the glass sheet of the monolithic glazing, respectively at least the outer glass sheet of the laminated glazing, each called “considered glass sheet” of the second glazing, comprising two main faces, a first main face, referred to as “outer”, intended to provide the interface with an external environment, and a second main face, opposite and separated by an edge face, referred to as “second edge face”, the second edge face of the considered glass sheet of the second glazing comprising, over at least part of the periphery of the considered glass sheet of the second glazing: a first convex curved part connected to the first main face of the considered glass sheet of the second glazing, a second convex curved part connected to the second main face of the considered glass sheet of the second glazing, a flat part connecting said first and second curved parts of the considered glass sheet of the second glazing, the intersection between the flat part and a curved part being formed, in a section transverse to the considered glass sheet of the second glazing, by a single point, the so-called contact part of the finishing joint and/or seal further being arranged facing said second edge face of the considered glass sheet of the second glazing and further comprising a second flat face in contact with the flat part of the second edge face of the considered glass sheet of the second glazing, the finishing joint and/or seal further comprising: a second protuberance arranged in the continuation of the second flat face of the contact part, said second protuberance covering at least a portion of the curved part of the second edge face connected to said outer main face of the considered glass sheet of the second glazing.
said second protuberance covers the entire curved part of the second edge face connected to said outer main face of the considered glass sheet of the second glazing.
at least a portion of the outer main face of the considered glass sheet of the first glazing connected to the first edge face, at least a portion of the outer main face of the considered glass sheet of the second glazing connected to the second edge face and an outer face of the contact part of said joint or seal are arranged with continuity of shape.
the first edge face and the second edge face are arranged facing one another in a direction substantially perpendicular to the normals of the flat parts of each of the edge faces.
at least one portion of the contact part of the finishing joint and/or seal comprising the first and second protuberances extends between at least one portion of the first edge face and one portion of the second edge face and joins said two first and second edge face portions together.
the first and second curved parts of the second edge face are arcs of circle, for example arcs of circle of identical respective radii and identical respective lengths.
the first and second curved parts of the second edge face are arcs of circles of identical respective radii and identical respective lengths, the flat part of the second edge face being orthogonal to the main faces.
the angle, referred to as the “machining opening” of the considered glass sheet of the second glazing, defining the gap between a first straight line tangential to the first curved part of the second edge face at the point of connection between said first curved part of the second edge face and the outer face defined for this glass sheet, a second straight line tangential to the second curved part of the second edge face at the point of connection between said second curved part and the second main face defined for this considered glass sheet, is between 20° and 120°, more particularly between 20° and 80°, preferentially between 20° and 50°, for example equal to 36°.
the first and second curved parts and the flat part of the second edge face are formed around the entire perimeter of the considered glass sheet of the second glazing.
the second glazing is a laminated glazing, the inner sheet of the second glazing conforming to the considered glass sheet of the second glazing as defined above.
the inner and outer sheets of the second glazing are arranged so that, in a cross-section of said glazing, the respective flat parts of said inner and outer sheets are aligned with the edge face of the interlayer film.

According to a seventh aspect, the invention relates to the manufacture of a glazed assembly as previously defined, the method comprising the machining of a glass sheet, the machining of the glass sheet comprising the steps of:
obtaining a glass sheet with a flat edge face,
inserting the glass sheet, by the edge face, into a groove of a rotating grinding wheel, said groove being provided with an abrasive surface, said insertion being carried out until the bottom of the groove is reached, which is shaped so that once the bottom is reached, the glass sheet conforming to the considered glass sheet of the first glazing as defined previously,
removing the glass sheet from the groove to obtain the considered glass sheet of the first glazing comprising the first edge face.

The method for manufacturing the glazed assembly may further comprise one or more of the following features in any technically possible combination:
the method comprises arranging a contact part of a finishing joint and/or seal facing the first edge face of the considered glass sheet of the first glazing and bringing a first flat face of the contact part into contact with the flat part of the first edge face of the considered glass sheet of the first glazing, and covering at least a portion of the curved part of the first edge face, advantageously the entire curved part of the first edge face, connected to said outer main face of the considered glass sheet of the first glazing by a first protuberance of the finishing joint and/or seal arranged in the continuation of the flat face of the contact part.
the method further comprises machining a further glass sheet, the machining of said further glass sheet comprising the steps of: obtaining a further glass sheet whose edge face is flat, inserting said further glass sheet, by the edge face, into a groove of a rotary grinding wheel, said groove being provided with an abrasive surface, said insertion being carried out until reaching the bottom of the groove which is shaped so that once the bottom is reached, said further glass sheet conforms to the considered glass sheet of the second glazing as previously defined, removing the glass sheet from the groove to obtain the considered glass sheet of the second glazing comprising the second edge face.
the method further comprises arranging the contact part of the finishing joint and/or seal facing said second edge face of the considered glass sheet of the second glazing and bringing a second flat face of the contact part of the finishing joint and/or seal into contact with the flat part of the second edge face of the considered glass sheet of the second glazing, and covering at least a portion of the curved part of the second edge face, advantageously the entire curved part of the second edge face, connected to said outer main face of the considered glass sheet of the second glazing by a second protuberance of the finishing joint and/or seal arranged in the continuation of the second flat face of the contact part.

According to an eighth aspect, the invention relates to the use of a glass assembly according to the invention in a motor vehicle, for example as a windshield, rear window and/or side window and/or glazed roof, or in a building.

According to a ninth aspect, the invention relates to a motor vehicle comprising a glazed assembly according to the invention.

### BRIEF DESCRIPTION OF THE DRAWINGS

Other features and advantages of the present invention will emerge from the non-limiting description given below, with reference to the appended drawings that illustrate an exemplary embodiment thereof. In the figures:

FIG. 1 schematically shows an example of a grinding wheel for machining the edge face of a glass sheet, as is known from the state of the art;

FIG. 2 schematically depicts a glazed assembly according to the state of the art, comprising a laminated glazing whose glass sheets have been machined using the grinding wheel shown in FIG. 1;

FIG. 3 schematically depicts a particular type of grinding wheel used to machine the edge face of a glass sheet, so as to obtain a machined glass sheet according to the invention;

FIG. 4 schematically depicts the glass sheet obtained after machining with the grinding wheel shown in FIG. 3;

FIG. 5 shows, in flowchart form, the main steps in a machining method according to the invention to produce the glass sheet shown in FIG. 4;

FIG. 6 schematically depicts a particular embodiment of a glazed assembly according to the invention, said glazed assembly comprising a laminated glazing, the outer glass sheet of which conforms to FIG. 3;

FIG. 7 schematically depicts a particular embodiment of a glazed assembly according to the invention, said glazed assembly comprising a monolithic glazing, the glass sheet of which conforms to FIG. 3;

FIG. 8 is a schematic perspective view of another particular embodiment of a glazed assembly according to the invention, said glazed assembly comprising a first laminated glazing and a second laminated glazing;

FIG. 9 is a schematic cross-sectional view of the glazed assembly of FIG. 8;

FIG. 10 is a schematic cross-sectional view of a variant of the glazed assembly shown in FIG. 9; and

FIG. 11 is a schematic cross-sectional view of a variant of the glazed assembly of claim 10.

### DESCRIPTION OF EMBODIMENTS

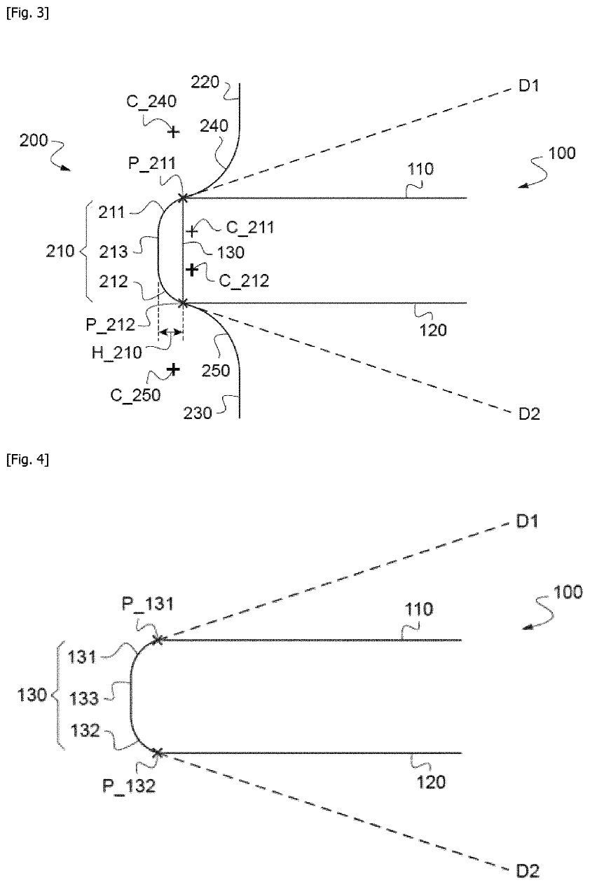

FIG. 3 schematically depicts a particular embodiment of a grinding wheel 200 used to machine the edge face 130 of a glass sheet 100, so as to obtain a machined glass sheet 100 according to the invention.

More particularly, FIG. 3 is a close-up partial view of a cross-section of the glass sheet 100 before it is machined.

For the remainder of this disclosure, it is assumed, without limitation, that the glass sheet 100 is intended to be used, after machining, to form a windshield for a motor vehicle, which may be a car, a bus, a truck, etc.

It should be noted, however, that considering a glass sheet to form a windshield for a motor vehicle is only one implementation alternative of the invention. However, there is nothing to prevent the use of a glass sheet according to the invention for another type of automotive glazing, such as a rear window, a side window or a glass roof.

More generally, the use of a glass sheet according to the invention is not limited to the automotive field, but can also be applied to the building field, for example to equip a window or a glazed facade.

For the remainder of the disclosure, it will also be assumed, without limitation, that the glass sheet 100 is machined around the entire perimeter of the glass sheet 100. Such arrangements are by no means restrictive of the invention, and nothing precludes the possibility of machining only part of the perimeter of the glass sheet 100. The choice of machining all or part of the perimeter of the glass sheet 100 is typically made based on the intended use of the sheet 100 once machined.

As shown in FIG. 3, the glass sheet 100 comprises two main faces, a first main face 110 (e.g. intended to face an external environment) and a second main face 120 (e.g. intended to face an internal environment). The two main faces 110, 120 are opposite one another, parallel and separated by the edge face 130. It should be noted that before machining, the edge face 130 is flat and orthogonal to the main faces 110, 120 (the glass sheet 100 resulting, for example, from a cutting operation in a larger glass plate).

In the embodiment of FIG. 3, the glass sheet 100 is shown in its initial machining configuration, that is, at the start of its insertion, by the edge face 130, into a groove 210 of the grinding wheel 200 (only part of the grinding wheel 200 is shown here due to the partial close-up view).

The groove 210 has a geometric configuration intended to be imparted to the edge face 130 of the sheet 100 following machining. “Intended to be conferred” means that once the glass sheet 100 has been inserted to the bottom of the groove 210, and then removed, the edge face 130 has a shape identical to that of the groove 210. As a result, describing the shape of the groove 210 is equivalent to describing the shape of the edge face 130 after machining, taking into account the fact that a shape considered to be concave on part of the groove 210 (that is, a shape re-entering toward the inside of the grinding wheel 200) will become a corresponding convex shape on part of the edge face 130 (that is, a shape exiting toward the outside of the glass sheet 100).

To give the edge face 130 a shape in keeping with the invention, the groove 210 has a generally concave shape, and its surface is provided with diamond particles (not shown in FIG. 3) suitable for machining the glass sheet 100.

More particularly, the geometric shape of the surface of the groove 210 comprises:
a first concave curved part 211, in contact with the junction edge between the edge face 130 and the first main face 110 of the glass sheet 100 when the latter is in the initial machining configuration,
a second convex curved part 212 in contact with the junction edge between the edge face 130 and the second main face 120 of the glass sheet 100 when the latter is in the initial machining configuration.

The geometric shape of the groove 210 further comprises a flat part 213 interconnecting said first and second curved parts 211, 212, this connection taking place between the ends of the first and second curved parts 211, 212 which are not in contact with the edge face 130 when the glass sheet 100 is in its initial machining configuration.

This flat part 213 is characterized in particular by the fact that its intersection with the curved part 211 (respectively its intersection with the curved part 212) is constituted, in a cross-section of the glass sheet 100, by a single point. These provisions therefore imply that the flat part 213 cannot form, in said cross-section of FIG. 3, a segment underlying all or part of the curved part 211 (respectively all or part of the curved part 212). In this way, the edge face 130 will acquire, as a result of machining, a flat part forming the end of the glass sheet 100 and hence configured to be in contact with a joint (finishing joint and/or seal) as detailed later.

It should be noted that “curved part”, for the purposes of the present invention, refers to a curved part making a connection between the flat part 213 and a main face 110, 120.

In the embodiment shown in FIG. 3, the first and second curved parts 211, 212 are more specifically arcs of circle. These arcs of circle 211, 212 have identical radii (that is, the lengths of these radii are equal) and identical respective lengths. The centers of the arcs are indicated by references C_211, C_212 in FIG. 3.

Considering curved parts 211, 212 in the form of arcs of circle is only one alternative embodiment of the invention. This does not preclude other embodiments wherein at least one curved part has a shape other than an arc of circle, e.g. elliptical, parabolic, etc.

Furthermore, in the embodiment shown in FIG. 3, the glass sheet 100 is positioned, in its initial machining configuration, so that the edge face 130 is parallel to the flat part 213. In this way, after machining, the edge face 130 also has a flat part, the latter being more particularly orthogonal to the main faces 110, 120.

The machining height H_210 is also shown in FIG. 3, and thus corresponds, in this embodiment, to the distance between the edge face 130 (when the glass sheet 100 is arranged in its initial machining configuration) and the flat part 213.

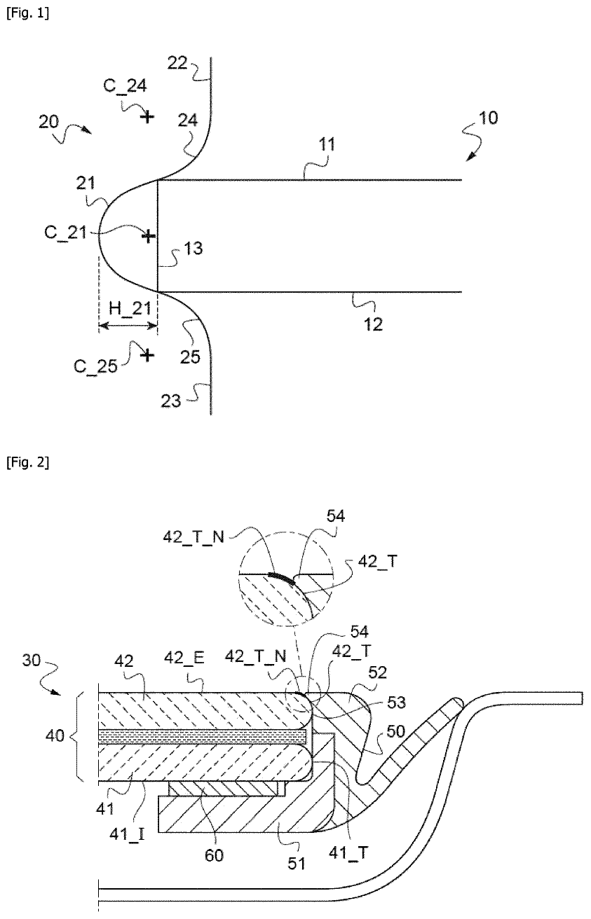

Similar to what has been disclosed above with reference to FIG. 1, and as shown in FIG. 3, the groove 210 is connected to edges 220, 230 of the grinding wheel 200 (these edges 220, 230 forming part of the periphery of the grinding wheel 200) by rounded surfaces 240, 250. These rounded surfaces correspond, in the embodiment disclosed here, to arcs of circle whose respective centers are indicated by references C_240, C_250 and whose respective radii are equal.

The geometric configuration of the groove 210 (position of centers C_211, C_212, radius values of associated arcs, machining height H_210) defines an angle, known as the “machining opening”, characterizing the way in which the glass sheet 100 is machined by the grinding wheel 200. More specifically, this machining opening defines the distance, when the glass sheet 100 is in the initial machining configuration, between two straight lines (shown as dotted lines in FIG. 3):
a first straight line D1 (dotted line) tangential to the first curved part 211 at the point of contact (referenced P_211 in FIG. 3) between said first curved part 211 and the edge face 130,
a second straight line D2 (dotted line) tangential to the second curved part 212 at the point of connection (referenced P_212 in FIG. 3) between said second curved part 212 and the edge face 130.

Said machining opening is, for example, between 20° and 120°, more particularly between 20° and 80°, preferentially between 20° and 50°. In particular, the inventors noted that reducing the machining opening (which also means increasing the length of the radii defining the arcs of circles of the curved parts 211, 212) reduces the risk of flaking at the edge of the edge face 130 during machining. In particular, a machining opening of less than 50° greatly reduces this risk.

It is clear from the above disclosure that the geometry of the edge face 130 after machining ultimately depends on all or some of the following parameters:
the shape of each of the curved parts 211, 212 (e.g. arc of circle),
the geometric characteristics of said curved parts (e.g. radius and length in the case of an arc of circle),
the machining height value,
the position of the glass sheet 100 in its initial machining configuration (e.g. perpendicular or inclined relative to the edge face of the grinding wheel 200),
the value of the machining opening.

An appropriate choice of one or more of these parameters thus ensures, in an example similar to FIG. 3, that the edge face 130 is orthogonal to the main faces 110, 120.

However, this does not preclude designs wherein, after machining, the edge face 130 of the glass sheet 100 is inclined relative to the main faces 110, 120. Such an inclination can be obtained by modifying any one or more of the above-mentioned parameters.

As a non-limiting example, the value of the arc radius (radii) of the curved part(s) is substantially or exactly equal to one third of the thickness of the glass sheet 100.

The machining height is, for example, between ⅓ and ⅕ of the thickness of the glass sheet 100, for example substantially or exactly equal to ¼ of the thickness of the glass sheet 100.

FIG. 4 schematically depicts the glass sheet 100 obtained after machining with the grinding wheel 200 shown in FIG. 3.

As shown in FIG. 4, the edge face 130 of the glass sheet 100, after machining, has a profile corresponding to that of the groove 210 of the grinding wheel 200.

To this end, the edge face 130 comprises:
a first convex curved part 131 connected to the first main face 110. This first curved part 131 has a shape corresponding to that of the first curved part 211 of the groove 210. The point of connection between this first curved part 131 and the first main face 110 is referenced P_131 in FIG. 4, and is coincident with the point P_211 when the glass sheet 100 is inserted at the bottom of the groove 210,
a second convex curved part 132 connected to the second main face 120. This second curved part 132 has a shape corresponding to that of the second curved part 212 of the groove 210. The point of connection between this second curved part 132 and the second main face 120 is referenced P_132 in FIG. 4, and is coincident with the point P_212 when the glass sheet 100 is inserted at the bottom of the groove 210,
a flat part 133 connecting said first and second curved parts 131, 132 to one another. This flat part 133 has a shape corresponding to that of the flat part 213 of the groove 210. To this end, the intersection between the flat part 133 and a curved part 131, 132 is constituted, in a cross-section of the glass sheet 100, by a single point.

The machining opening defined above in connection with the groove 210 of the grinding wheel 200 is of course equivalent for the glass sheet 100. To this end, for the glass sheet 100 and as shown in FIG. 4, said machining opening corresponds to the angle defining the distance between two straight lines (shown in dotted lines in FIG. 4):
a first straight line D1 tangential to the first curved part 131 at the point of connection P_131,
a second straight line D2 tangential to the second curved part 132 at the point of connection P_132.

It should be noted that in this example of FIG. 4, it is equivalent to define the machining opening as the angular distance between the straight lines D1 and D2, or as the angular distance between the straight line D1 (respectively the straight line D2) and the first main face 110 (respectively the second main face 120). Indeed, due to the symmetry of the machined glass sheet with respect to the perpendicular bisector of the flat part 133, the angular distances between these straight lines D1, D2 and their associated main faces are equal. However, the invention is not limited by such arrangements, and, as already mentioned, by modifying one or more of the parameters listed above, it is possible to envisage embodiments wherein the angular deviation between the straight line D1 and the face 110 differs from the angular deviation between the straight line D2 and the face 120.

Several example embodiments of glass sheets according to the invention are now disclosed:
Example No. 1: The thickness of the glass sheet is equal to 1.1 mm, the machining height is equal to 0.24 mm, the machining opening is equal to 36°, the first and second curved parts of the edge face are arcs of circle of the same radius equal to 0.35 mm and of the same length, the center of an arc of circle is located on the straight line orthogonal to the flat part of the edge face and passing through the junction point between said flat part and said arc of circle;
Example No. 2: The thickness of the glass sheet is equal to 1.6 mm, the machining height is equal to 0.38 mm, the machining opening is equal to 36°, the first and second curved parts of the edge face are arcs of circle of the same radius equal to 0.55 mm and of the same length, the center of an arc of circle is located on the straight line orthogonal to the flat part of the edge face and passing through the junction point between said flat part and said arc of circle;
Example No. 3: The thickness of the glass sheet is equal to 1.8 mm, the machining height is equal to 0.41 mm, the machining opening is equal to 36°, the first and second curved parts of the edge face are arcs of circle of the same radius equal to 0.6 mm and of the same length, the center of an arc of circle is located on the straight line orthogonal to the flat part of the edge face and passing through the junction point between said flat part and said arc of circle;
Example No. 4: The thickness of the glass sheet is equal to 2.1 mm, the machining height is equal to 0.48 mm, the machining opening is equal to 36°, the first and second curved parts of the edge face are arcs of circle of the same radius equal to 0.7 mm and of the same length, the center of an arc of circle is located on the straight line orthogonal to the flat part of the edge face and passing through the junction point between said flat part and said arc of circle;
Example No. 5: The thickness of the glass sheet is equal to 2.6 mm, the machining height is equal to 0.59 mm, the machining opening is equal to 36°, the first and second curved parts of the edge face are arcs of circle of the same radius equal to 0.85 mm and of the same length, the center of an arc of circle is located on the straight line orthogonal to the flat part of the edge face and passing through the junction point between said flat part and said arc of circle.

Of course, Examples 1-5 are for illustrative purposes only. In particular, there is no limitation on the numerical values relating to glass thickness, machining height, arc radius or machining opening, provided that the edge face 130 has a profile in accordance with the invention.

It may also be noted that in these Examples No. 1-5, the value of an arc radius is substantially or exactly equal to a third of the glass thickness. Here again, however, such provisions are not limiting with respect to the invention.

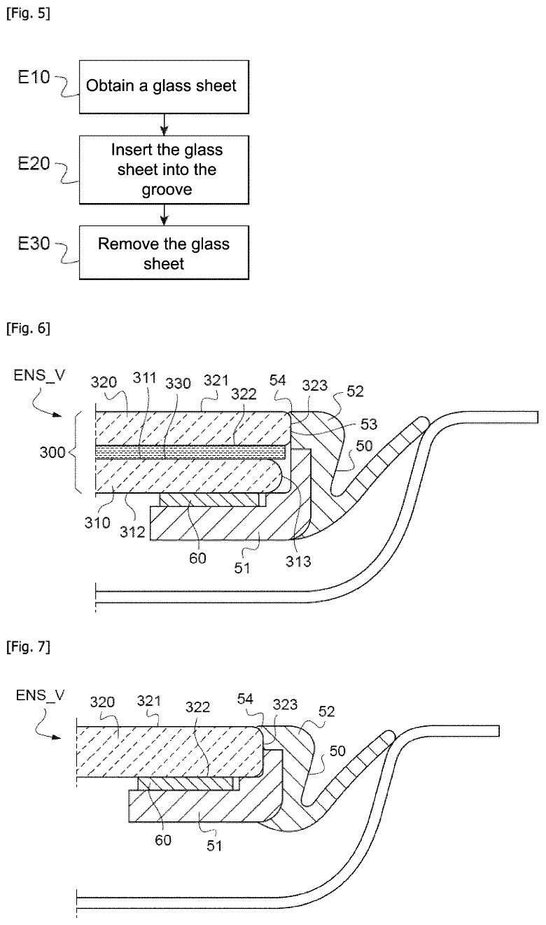

According to another aspect, the invention is also aimed at a method for machining a glass sheet. FIG. 5 shows, in flowchart form, the main steps in said machining method to produce the glass sheet 100 shown in FIG. 4.

As shown in FIG. 5, the method first comprises a step E10 to obtain a glass sheet 100 with a flat edge face (that is, the edge face is completely flat before machining).

In a particular embodiment, obtaining the glass sheet 100 refers only to providing it, after it has been cut from a glass plate, for example.

In another particular embodiment, the obtaining step E10 comprises cutting a glass sheet so as to form said glass sheet 100 with a flat edge face.

Said glass sheet 100 is then inserted, by the edge face 130, into the groove 210 of the rotary grinding wheel 200. This insertion is the subject of step E20 of the machining method, and is carried out until the edge face 130 of the glass sheet 100 reaches the bottom of the groove 210.

Once insertion is complete (that is, once the edge face 130 of the glass sheet 100 has reached the bottom of the groove 210), the method comprises a final step E30 to remove the glass sheet 100, whose edge face 130 is now machined to the shape of the groove 210.

In addition to a machined glass sheet and a machining method as described above, the invention also covers other aspects, namely a glazing comprising such a machined glass sheet and a glazed assembly comprising said glazing.

FIG. 6 schematically depicts a particular embodiment of a glazed assembly ENS_V according to the invention.

In the embodiment shown in FIG. 6, said glazed assembly ENS_V comprises a laminated glazing 300 for a motor vehicle. Said laminated glazing 300 comprises two glass sheets, an inner sheet 310 and an outer sheet 320, separated by an interlayer film 330.

The inner glass sheet 310 (respectively the outer glass sheet 320) is intended to be arranged on the inside of the car, that is, in contact with the car's interior (respectively to be arranged on the outside of the car, that is, in direct contact with the atmosphere outside the car).

Each glass sheet 310, 320 has a first main face 311, 321, called “outer”, intended to face the outside of the vehicle, as well as a second opposite main face 312, 322, called “inner”. The inner and outer faces of a sheet are joined together by a peripheral edge face 313, 323. Conventionally, the inner faces 321, 322 of the outer sheet 320 (respectively the inner and outer faces 311, 312 of the inner sheet 310) are also referred to respectively as face F1 and face F2 (respectively face F3 and face F4).

There is no limitation on the type of glass used to form the glass sheets 310, 320. It can be either organic or mineral glass. The glass sheets 310, 320 can further be untempered, partially tempered or tempered glass.

By way of example, the outer 320 and/or inner 310 glass sheet is made of soda-lime glass, quartz glass, borosilicate glass or alumino-silicate glass. In other examples, the outer 320 and/or inner 310 glass sheet is made from rigid, transparent plastics, such as polycarbonate, polyethylene terephthalate (PET) or polymethyl methacrylate.

For the inner sheet 310, a colorless soda-lime mineral glass such as the glass Planilux® marketed by the applicant will preferably be used. The inner sheet 310 typically has a thickness of between 1.4 and 3.2 mm, preferably between 1.4 and 2.1 mm (this thickness can vary between 2.5 and 6 mm in the case of single glazing, that is, monolithic and non-laminated).

The outer sheet 320 can of course be as transparent and colorless as the inner sheet 310. In some exemplary embodiments, a laminated glazing according to the invention will consist of two colorless Planilux® sheets.

Unlike the inner sheet 310, the outer sheet 320 is advantageously made of tinted glass, for example Venus®, TSA3+ or TSA4+ glass, also marketed by the Applicant. The outer sheet 320 typically has a thickness in the range between 1.4 and 2.1 mm.

In more specific exemplary embodiments (not shown in the figures), said laminated glazing may comprise a functional layer. There is no limitation on the nature of the functional layer. For example, it could be a layer that reflects infrared radiation. Generally speaking, the person skilled in the art knows which functional layers can be envisaged for a laminated glazing of a motor vehicle, and also knows where to position (that is, on which face of the glazing) such a functional layer. Consequently, these aspects are not described further here.

The interlayer film 330, meanwhile, is in adhesive contact with the two glass sheets 310, 320, and more specifically with the first main face 321 of the outer sheet 320 and the second main face 312 of the inner sheet 310. It can be made of any transparent polymer material commonly used for this purpose, such as polyvinyl butyral (PVB), thermoplastic polyurethane (TPU) or ethylene vinyl acetate copolymer (EVA). The interlayer typically has a thickness in the range between 0.2 and 1.1 mm and may be colorless or tinted in sections or fully tinted.

The glazing 300 is also characterized by the fact that the outer sheet 320 is machined in accordance with the invention. More specifically, in the embodiment disclosed here, the outer sheet 320 has an edge face 323 whose profile is identical to that disclosed above for the glass sheet in FIG. 4.

It should be noted that the inner glass sheet 310, in terms of the shape of its edge face 313, conforms to the state of the art. More specifically, in the embodiment disclosed here, the inner sheet 310 has an edge face 313 whose profile is identical to that disclosed above for the inner/outer sheet in FIG. 2.

However, considering a glazing 300 wherein only the outer sheet 320 has an edge face 323 comprising curved parts as well as a flat part is only one variant of the invention. This does not preclude other embodiments wherein both the outer and inner glass sheets of a laminated glazing are machined in accordance with the invention.

Even more specifically, when said inner and outer sheets are machined in accordance with the invention, it may be envisaged that they are arranged so that, in a cross-section of the glazing, the respective flat parts of said inner and outer sheets are aligned with the edge face of the interlayer film.

In addition to the glazing 300, the glazed assembly ENS_V also comprises a finishing joint with the same technical characteristics as those disclosed for the finishing joint 50 in FIG. 1, whose numerical references are repeated here. It should be noted, however, that the use of a joint or seal with only finishing properties is not limiting with respect to the invention, and nothing of course precludes the consideration of a joint or seal with only sealing properties, or with both finishing and sealing properties.

Thus, in the embodiment shown in FIG. 6, the finishing joint 50 comprises:
an “attachment” part 51 held in contact with the inner face 312 of the inner sheet 310 by adhesive means 60 of a type known per se,
a “contact” part 52 facing the edge face of the glazing 300 (that is, facing the edge faces 313, 323 of the inner and outer sheets 310, 320) and comprising a flat face 53 in contact with the edge face 323 of the outer glass sheet 320,
a protuberance 54 arranged in the continuation of the flat face 53 of the contact part 52. In this example, said protuberance 54 is designed to be flush with the outer face 321 of the outer glass sheet 320.

The attachment part 51, for example, is made of a harder material than the contact part 52. Nonetheless, in the non-limiting embodiment described here, the joint or seal 50 forms a single part produced in a manner known per se, typically by extrusion.

As shown in FIG. 6, the joint or seal 50, and more specifically the protuberance 54, completely covers the curved part of the edge face 323 connected to the outer main face 321 of the outer sheet 320. As a result, no part of the edge face 323 of the outer sheet 320 is left exposed. This is due to the presence of the flat part of the edge face 323 of the outer glass sheet 320. In contrast to the configuration shown in FIG. 2, the joint or seal 50 is not constrained to a fully rounded edge, but can instead be pressed against the flat part of the edge face 323.

It should be noted that attaching the joint or seal 50 to the glazing 300 via the attachment part 51 and the adhesive means 60 is only one variant of the invention. In general, any method known to the skilled person for attaching a joint or seal comprising at least one contact part 52 and a protuberance 54 can be envisaged.

Additionally, the glazed assembly ENS_V has so far been disclosed on the assumption that the glazing 300 fitted thereto is laminated. Of course, these provisions are not limiting with respect to the invention, which also covers the case of a glazed assembly equipped with a monolithic glazing. Such a configuration is shown in FIG. 7, wherein the numerical references of FIG. 6 have been used for the corresponding elements.

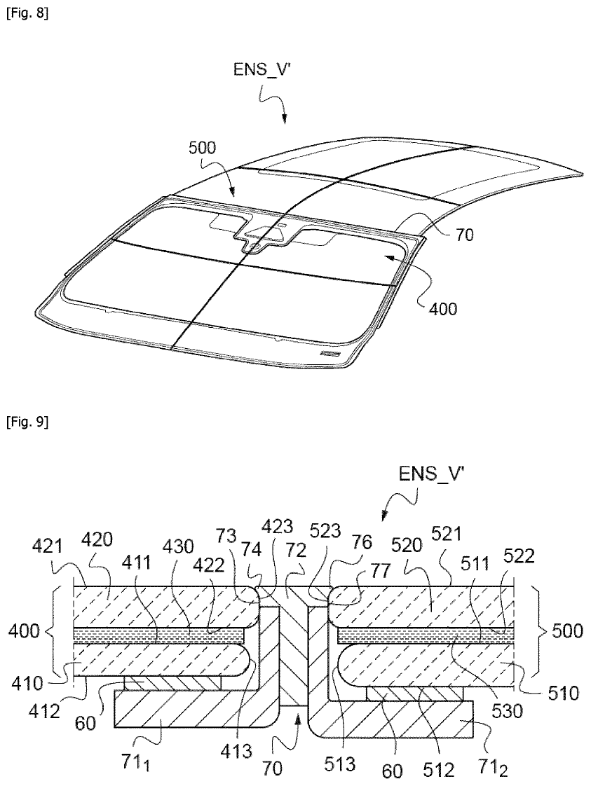

FIGS. 8 and 9 schematically depicts another particular embodiment of a glazed assembly ENS_V′ according to the invention.

The glazed assembly ENS_V′ shown in FIGS. 8 and 9 is disclosed only in contrast to the glazed assembly ENS_V disclosed with reference to FIG. 6.

In the embodiment shown in FIGS. 8 and 9, said glazed assembly ENS_V′ for a motor vehicle comprises a first laminated glazing 400, a second laminated glazing 500 and a finishing joint 70.

The first laminated glazing 400 is, for example, part of a vehicle windshield, and the second laminated glazing 500 is, for example, part of a vehicle roof.

Alternatively, the first laminated glazing is part of a vehicle windshield and the second laminated glazing is part of a vehicle side window. Alternatively, the first laminated glazing forms part of a first side window of the vehicle and the second laminated glazing forms part of a second side window of the vehicle. Alternatively, the first laminated glazing is part of a vehicle window and the second laminated glazing is part of a vehicle side window or roof.

The first glazing 400 and the second glazing are spaced apart.

The first laminated glazing 400 is analogous to the laminated glazing 300 of the assembly ENS_V disclosed in view of FIG. 6.

The first laminated glazing 400 comprises two glass sheets 410, 420, an inner sheet 410 analogous to the inner sheet 310 of the laminated glazing 300 and an outer sheet 420 analogous to the outer sheet 320 of the laminated glazing 300, separated by an interlayer film 430 analogous to the interlayer film 330 of the laminated glazing 300.

The inner glass sheet 410 (respectively the outer glass sheet 420) is intended to be arranged on the inside of the car, that is, in contact with the car's interior (respectively to be arranged on the outside of the car, that is, in direct contact with the atmosphere outside the car).

Each glass sheet 410, 420 has a first main face 411, 421, called “outer main face”, intended to face the outside of the vehicle, as well as a second opposite main face 412, 422, called “inner main face”. The inner and outer faces of a sheet are joined together by a peripheral edge face 413, 423. Conventionally, the first and second main faces 421, 422 of the outer sheet 420 (respectively the first and second main faces 411, 412 of the inner sheet 410) are also referred to respectively as face F1 and face F2 (respectively face F3 and face F4).

The first glazing 400 is also characterized by the fact that the outer sheet 420 is machined in accordance with the invention. More specifically, in the embodiment disclosed here, the outer sheet 420 of the first glazing 400 has an edge face 423 whose profile is identical to the edge face 323 disclosed above for the glass sheet 320 in FIG. 6. The edge face 423 of the outer sheet 420 of the first glazing 400 is referred to hereinafter as the “first edge face 423”.

In this particular example, the inner sheet 410 of the first glazing 400 is analogous to the inner sheet 310 of the glazing 300 of the glazed assembly ENS_V disclosed in view of FIG. 6.

The second laminated glazing 500 is analogous to the laminated glazing 300 of the assembly ENS_V disclosed in view of FIG. 6.

The second laminated glazing 500 comprises two glass sheets, an inner sheet 510 analogous to the inner sheet 310 of the laminated glazing 300 and an outer sheet 520 analogous to the outer sheet 320 of the laminated glazing 300, separated by an interlayer film 530 analogous to the interlayer film of the laminated glazing 300.

The inner glass sheet 510 (respectively the outer glass sheet 520) is intended to be arranged on the inside of the car, that is, in contact with the car's interior (respectively to be arranged on the outside of the car, that is, in direct contact with the atmosphere outside the car).

Each glass sheet 510, 520 has a first main face 511, 521, called “outer main face”, intended to face the outside of the vehicle, as well as a second opposite main face 512, 522, called “inner main face”. The inner and outer faces of a sheet are joined together by a peripheral edge face 513, 523. Conventionally, the first and second main faces 521, 522 of the outer sheet 520 (respectively the first and second main faces 511, 512 of the inner sheet 510) are also referred to respectively as face F1 and face F2 (respectively face F3 and face F4).

The second glazing 500 is also characterized by the fact that the outer sheet 520 is machined in accordance with the invention. More specifically, in the embodiment disclosed here, the outer sheet 520 of the second glazing 500 has an edge face 523 whose profile is identical to that disclosed above for the glass sheet 320 in FIG. 4. The edge face 523 of the outer sheet 520 of the second glazing 500 is referred to hereinafter as the “second edge face 523”.

According to a particular example, the first edge face 423 and the second edge face 523 are arranged facing one another in a direction substantially perpendicular to the normals of the flat faces 73, 77 of each of said edge faces 423, 523.

In this particular example, the inner glass sheet 510 of the second glazing 500 is analogous to the inner sheet 310 of the glazing 300 of the glazed assembly ENS_V disclosed in view of FIG. 6.

The finishing joint 70 of the glazed assembly ENS_V′ of the present embodiment comprises a first attachment part 71₁, a second attachment part 71₂, a contact part 72, a first protuberance 74 and a second protuberance 76.

The first attachment part 71₁ is held in contact with the inner face 412 of the inner sheet 410 of the first glazing 400 by adhesive means 60 of a type known per se.

The second attachment part 71₂ is held in contact with the inner face 512 of the inner sheet 510 of the second glazing 500 by adhesive means 60 of a type known per se.

The contact part 72 is arranged opposite the edge face of the first glazing (that is, opposite the edge faces 413, 423 of the inner 410 and outer 420 sheets of the first glazing 400) and opposite the edge face of the second glazing 500 (that is, opposite the edge faces 513, 523 of the inner 510 and outer 520 sheets of the second glazing 500).

The contact part 72 of the joint or seal 70 extends between at least a portion of the first edge face 423 and a portion of the second edge face 523 and joins said two portions of the first and second edge faces 423, 523 together.

According to a particular embodiment, the outer face 421 of the outer sheet 420 of the first glazing 400, the outer face 521 of the outer sheet 520 of the second glazing 500 and an outer face of the contact part 72 (that is, the face of the contact part in contact with the environment) are arranged with continuity of shape.

The contact part 72 comprises a first flat face 73 and a second flat face 77.

The first flat face 73 of the contact part 72 is in contact with the first edge face 423.

The second flat face 77 of the contact part 72 is in contact with the second edge face 523.

According to a particular example, the first and second flat faces 73, 77 of the contact part 72 are spaced apart along a direction parallel to the spacing direction of the first and second glazings 400, 500.

The first protuberance 74 is arranged in the continuation of the first flat face 73 of the contact part 52.

Said first protuberance 74 is designed to be flush with the outer face 421 of the outer glass sheet 420 of the second glazing 400.

As shown in FIG. 9, the first protuberance 74 completely covers the curved part of the first edge face 423 connected to the outer main face 421 of the outer sheet 420 of the first glazing 400. As a result, no part of the first edge face 423 of the outer sheet 420 of the first glazing 400 is left exposed. This is due to the presence of the first flat part of the first edge face 423 of the outer glass sheet 420 of the first glazing 400.

The second protuberance 76 is arranged in the continuation of the second flat face 77 of the contact part 72.

In this example, said second protuberance 76 is designed to be flush with the outer face 521 of the outer glass sheet 520 of the second glazing 500.

As also shown in FIG. 9, the second protuberance 76 completely covers the curved part of the second edge face 523 connected to the outer main face 521 of the outer sheet 520 of the second glazing 500. As a result, no part of the second edge face 523 is left exposed. This result is due to the presence of the second flat part of the second edge face 523.

A method for manufacturing the glazed assembly ENS_V′ is disclosed below.

The method comprises making the first glazing 400, making the second glazing 500 and joining the joint or seal 70 to the first and second glazings 400, 500.

Producing the first glazing 400 comprises machining a glass sheet to obtain the outer sheet 420 of the first glazing 400 comprising the first edge face 523.

The glass sheet is machined in accordance with the invention.

Once the glass sheet has been machined, the outer sheet 423 of the first glazing 400 comprising the first edge face 423 is obtained.

The method further comprises assembling the outer sheet 420 and the inner sheet 410 with the interlayer film 430 to obtain the first glazing 400.

Producing the second glazing 500 comprises machining a glass sheet to obtain the outer sheet 520 of the second glazing 500 comprising the second edge face 523.

The glass sheet is machined in accordance with the invention.

Once the glass sheet has been machined, the outer sheet 520 of the second glazing 500 comprising the second edge face 523 is obtained.

The method further comprises assembling the obtained outer sheet 520 and the inner sheet 510 with the interlayer film 530 to obtain the second glazing 500.

The assembly of the joint or seal 70 to the first and second glazings 400, 500 involves arranging the contact part 72 of the joint or seal 70 opposite the first edge face 423 and opposite the second edge face 523.

The assembly of the joint or seal 70 further comprises contacting the flat part of the first edge face 423 with first flat face 73 of the contact part 72 of the joint or seal 70 and contacting the flat part of the second edge face 523 with the second flat face 77 of the contact part 72 of the joint or seal 70.

Additionally, the method comprises, in this example, contacting the entire curved part of the first edge face 423 connected to said outer face 421 of the outer sheet 420 of the first glazing 400 by the first protuberance 74 of the joint or seal 70 and contacting the entire curved part of the second edge face 524 connected to said outer face 521 of the outer sheet 520 of the second glazing 500 by the second protuberance 74 of the joint or seal 70.

Additionally, the assembly comprises securing the joint or seal 70 to the first and second glazings 400, 500. In particular, the first attachment part 71₁ of the joint or seal 70 is attached to the inner face 412 of the inner sheet 410 of the first glazing 400 and the second attachment part 71₂ of the joint or seal 70 is attached to the inner face 512 of the inner sheet 510 of the second glazing 500.

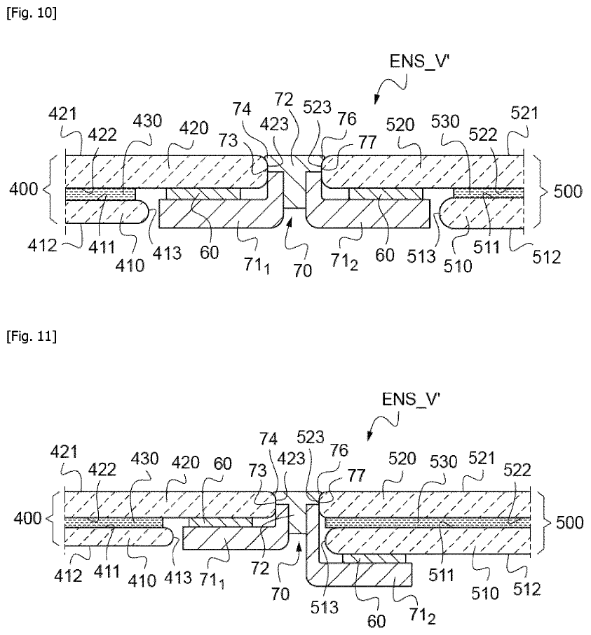

A variant of the glazed assembly ENS_V′ is shown in FIG. 10. The glazed assembly ENS_V′ shown in FIG. 10 is described only in contrast to the glazed assembly ENS_V′ disclosed with reference to FIG. 9. In FIG. 10, the numerical references of FIG. 9 have been used for the corresponding elements.

The glazed assembly ENS_V′ in FIG. 10 differs from the glazed assembly in FIG. 9 in that the edge faces 413, 513 of the inner sheets 410, 510 of the first and second glazings 400, 500 are not aligned with the first edge face 423 of the outer sheet 420 of the first glazing 400, respectively with the second edge face 523 of the outer sheet 520 of the second glazing 500.

In particular, the edge face 413 of the inner sheet 410 of the first glazing 400 and the edge face 513 of the inner sheet 510 of the second glazing 500 are recessed toward the inside of the first glazing 400, respectively the second glazing 500.

In other words, a portion of the outer sheet 420 of the first glazing 400 comprising the first edge face 423 protrudes from a portion of the inner sheet 410 of the first glazing 400 comprising the edge face 413. Additionally, a portion of the outer sheet 520 of the second glazing 500 comprising the second edge face 523 protrudes from a portion of the inner sheet 510 of the second glazing 500 comprising the edge face 513.

As can be seen in FIG. 10, the first attachment part 71₁ is held in contact by the adhesive means 60 with the inner face 422 of the outer sheet 420 of the first glazing 400, and in particular with the inner face 422 of the portion of the outer sheet 420 projecting from the inner sheet 410 of the first glazing 400, comprising the edge face 413.

Additionally, as can be seen in FIG. 10, the second attachment part 71₂ is held in contact by the adhesive means 60 with the inner face 522 of the outer sheet 520 of the second glazing 500, and in particular with the inner face 522 of the portion of the outer sheet 520 projecting from the inner sheet 510 of the second glazing 500, comprising the edge face 513.

A variant of the glazed assembly ENS_V′ shown in FIG. 10 is depicted in FIG. 11. This variant is described only in contrast to the glazed assembly disclosed with reference to FIG. 10.

The glazed assembly in FIG. 11 differs from the glazed assembly in FIG. 10 in that only the edge face 413 of the inner sheet 410 of the first glazing 400 is recessed relative to the first edge face 423 of the outer sheet 420 of the first glazing 400.

Thus, as can be seen in FIG. 11, the first attachment part 71₁ is held in contact by the adhesive means 60 with the inner face 422 of the outer sheet 420 of the first glazing 400, and in particular with the inner face 422 of the portion of the outer sheet 420 projecting from the inner sheet 410 of the first glazing 400, comprising the edge face 413.

Additionally, as can be seen in FIG. 10, the second attachment part 71₂ is held in contact with the inner face 512 of the inner sheet 510 of the second glazing 500 by the adhesive means 60.

Additionally, the glazed assembly ENS_V′ shown in FIGS. 9 to 11 has so far been described on the basis that the first glazing 400 and the second glazing 500 fitted thereto are laminated. Of course, these provisions are not limiting with respect to the invention, which also covers the case of an equipped glazed assembly wherein one or the other of the first and second glazings is a monolithic glazing.

1. A glazed assembly comprising a first glazing and a finishing joint and/or seal, the first glazing being a monolithic glazing comprising a glass sheet or the first glazing being a laminated glazing comprising two glass sheets, an inner sheet and an outer sheet, separated by an interlayer film,
the glass sheet of the monolithic glazing, respectively at least the outer sheet of the laminated glazing, each called “considered glass sheet” of the first glazing, comprising a first main face, called “outer main face”, designed to interface with an external environment and a second main face, opposed and separated by an edge face, called “first edge face”,
the first edge face of the considered glass sheet of the first glazing comprising, over at least part of the perimeter of said considered glass sheet:
a first convex curved part connected to the first main face of the considered glass sheet of the first glazing,
a second convex curved part connected to the second main face of the considered glass sheet of the first glazing,
a flat part connecting said first and second curved parts to one another,
the intersection between the flat part and a curved part being constituted, in a cross-section of the considered glass sheet of the first glazing, by a single point,
the finishing joint and/or seal comprising:
a contact part facing the first edge face of the considered glass sheet of the first glazing and comprising a flat face in contact with the flat part of the first edge face of the considered glass sheet of the first glazing,
a first protuberance arranged in the continuation of the flat face of the contact part, said first protuberance covering at least a portion of the curved part of the first edge face connected to said first main face of the considered glass sheet of the first glazing.

2. The glazed assembly according to claim 1, wherein said first protuberance covers the entire curved part of the first edge face connected to said first main face of the considered glass sheet of the first glazing.

3. (canceled)

4. The glazed assembly according to claim 1, wherein the first and second curved parts of the first edge face are arcs of circles of identical respective radii and identical respective lengths, the flat part being orthogonal to the main faces.

5. The glazed assembly according to claim 4, wherein the angle, referred to as the “machining opening” of the considered glass sheet of the first glazing, defining the gap between:
a first straight line tangential to the first curved part of the first edge face at the point of connection between said first curved part and the first main face,
a second straight line tangential to the second curved part at the point of connection between said second curved part and the second main face,
is between 20° and 120°.

6. The glazed assembly according to claim 1, wherein the first and second curved parts and the flat part of the first edge face are formed around the entire perimeter of the considered glass sheet of the first glazing.

7. The glazed assembly according to claim 1, wherein the first glazing is a laminated glazing, the inner sheet of the first glazing conforming to the considered glass sheet of the first glazing.

8. The glazed assembly according to claim 7, wherein the inner and outer sheets of the first glazing are arranged so that, in a cross-section of the first glazing, the respective flat parts of said inner and outer sheets are aligned with the edge face of the interlayer film.

9. The glazed assembly according to claim 1, further comprising a second glazing,
the second glazing being chosen from a monolithic glazing comprising one glass sheet or a laminated glazing comprising two glass sheets, an inner sheet and an outer sheet, separated by an interlayer film, the glass sheet of the monolithic glazing, respectively at least the outer glass sheet of the laminated glazing, each called “considered glass sheet” of the second glazing, comprising two main faces, a first main face, called “outer main face”, designed to interface with an external environment and a second main face (522), opposed and separated by an edge face, called “second edge face”,
the second edge face of the considered glass sheet of the second glazing comprising, over at least part of the perimeter of the considered glass sheet of the second glazing:
a first convex curved part connected to the first main face of the considered glass sheet of the second glazing,
a second convex curved part connected to the second main face of the considered glass sheet of the second glazing,
a flat part connecting said first and second curved parts of the considered glass sheet of the second glazing to one another,
the intersection between the flat part and a curved part being constituted, in a cross-section of the considered glass sheet of the second glazing, by a single point,
the contact part of the finishing joint and/or seal further being arranged facing said second edge face of the considered glass sheet of the second glazing and further comprising a second flat face in contact with the flat part of the second edge face of the considered glass sheet of the second glazing,
the finishing joint and/or seal further comprising:
a second protuberance arranged in the continuation of the second flat face of the contact part, said second protuberance covering at least a portion of the curved part of the second edge face connected to said first main face of the considered glass sheet of the second glazing.

10. The glazed assembly according to claim 9, wherein said second protuberance covers the entire curved part of the second edge face connected to said first main face of the considered glass sheet of the second glazing.

11. The glazed assembly according to claim 9, wherein at least a portion of the first main face of the considered glass sheet of the first glazing connected to the first edge face, at least a portion of the first main face of the considered glass sheet of the second glazing connected to the second edge face and an outer face of the contact part of said joint or seal are arranged with continuity of shape.

12. The glazed assembly according to claim 9, wherein the first edge face and the second edge face are arranged facing one another in a direction substantially perpendicular to the normals of the flat parts of each of said edge faces.

13. The glazed assembly according to claim 9, wherein at least one portion of the contact part of the finishing joint and/or seal comprising the first and second protuberances extends between at least one portion of the first edge face and one portion of the second edge face and joins said two first and second edge face portions together.

14. The glazed assembly according to claim 9, wherein the first and second curved parts of the second edge face are arcs of circle.

15. The glazed assembly according to claim 9, wherein the first and second curved parts of the second edge face are arcs of circle of identical respective radii and identical respective lengths, the flat part of the second edge face being orthogonal to the main faces.

16. The glazed assembly according to claim 15, wherein the angle, referred to as the “machining opening”, of the considered glass sheet of the second glazing, defining the gap between:
a first straight line tangential to the first curved part of the second edge face at the point of connection between said first curved part of the second edge face and the outer face defined for this considered glass sheet,
a second straight line tangential to the second curved part of the second edge face at the point of connection between said second curved part and the second main face defined for this considered glass sheet,
is between 20° and 120°.

17. The glazed assembly according to claim 9, wherein the first and second curved parts and the flat part of the second edge face are formed around the entire perimeter of the considered glass sheet of the second glazing.

18. The glazed assembly according to claim 9, wherein the second glazing is a laminated glazing, the inner sheet of the second glazing conforming to the considered glass sheet of the second glazing.

19. The glazed assembly according to claim 18, wherein the inner and outer sheets of the second glazing are arranged so that, in a cross-section of said glazing, the respective flat parts of said inner and outer sheets are aligned with the edge face of the interlayer film.

20. A method of manufacturing a glazed assembly according to claims 1, the method comprising machining a glass sheet, machining the glass sheet comprising the steps of:
obtaining a glass sheet with a flat edge face,
inserting the glass sheet, by the edge face, into a groove of a rotating grinding wheel, said groove being provided with an abrasive surface, said insertion being carried out until the bottom of the groove is reached, which is shaped so that once the bottom is reached, the glass sheet conforming to the considered glass sheet of the first glazing,
removing the glass sheet from the groove to obtain the considered glass sheet of the first glazing comprising the first edge face.

21. The method of manufacturing a glazed assembly according to claim 20, comprising:
arranging a contact part of a finishing joint and/or seal facing the first edge face of the considered glass sheet of the first glazing and bringing a first flat face of the contact part into contact with the flat part of the first edge face of the considered glass sheet of the first glazing, and
covering at least a portion of the curved part of the first edge face connected to said first main face of the considered glass sheet of the first glazing by a first protuberance of the finishing joint and/or seal arranged in the continuation of the first flat face of the contact part.

22. The method of manufacturing a glazed assembly according to claim 9, the method comprising machining a glass sheet, machining the glass sheet comprising the steps of:
obtaining a glass sheet with a flat edge face,
inserting the glass sheet, by the edge face, into a groove of a rotating grinding wheel, said groove being provided with an abrasive surface, said insertion being carried out until the bottom of the groove is reached, which is shaped so that once the bottom is reached, the glass sheet conforming to the considered glass sheet of the first glazing,
removing the glass sheet from the groove to obtain the considered glass sheet of the first glazing comprising the first edge face, and the method further comprising machining another glass sheet, machining the other glass sheet comprising the steps of:
obtaining another glass sheet with a flat edge face,
inserting said other glass sheet, by the edge face, into a groove of a rotating grinding wheel, said groove being provided with an abrasive surface, said insertion being carried out until the bottom of the groove is reached, which is shaped so that once the bottom is reached, said other glass sheet conforming to the considered glass sheet of the second glazing,
removing the glass sheet from the groove to obtain the considered glass sheet of the second glazing comprising the second edge face.

23. The method of manufacturing a glazed assembly according to claim 22, further comprising:
arranging the contact part of the finishing joint and/or seal facing said second edge face of the considered glass sheet of the second glazing and bringing a second flat face of the contact part of the finishing joint and/or seal into contact with the flat part of the second edge face of the considered glass sheet of the second glazing, and
covering at least a portion of the curved part of the second edge face connected to said first main face of the considered glass sheet of the second glazing by a second protuberance of the finishing joint and/or seal arranged in the continuation of the second flat face of the contact part.

24. A method comprising providing a glazed assembly according to claim 1 in a motor vehicle or in a building.

25. A motor vehicle comprising a glazed assembly according to claim 1.
